(19) United States
(12) Patent Application Publication
(10) Pub. No.: US 2006/0135673 A1
(43) Pub. Date: Jun. 22, 2006

(54) Fluorochemical esters blends as repellent polymer melt additives

(76) Inventors: John A. Temperante, Woodbury, MN (US); Chetan P. Jariwala, Woodbury, MN (US)

Correspondence Address: 3M INNOVATIVE PROPERTIES COMPANY, PO BOX 33427, ST. PAUL, MN, 55133-3427, US

(21) Appl. No.: 11/012,566

(22) Filed: Dec. 15, 2004

(51) Int. Cl. C08F 220/24

(52) U.S. Cl. 524/463

(57) ABSTRACT

A thermoplastic polymer comprising a blend of a first fluorochemical ester composition of the formula (I):
[Rₕ(CO₂)]ₘ-A-[(CO₂)-QRf¹]ₙ (I)
wherein A is the residue of a polyol, polyacid or mixed bydroxy acid, optionally having one or more unreacted hydroxyl or carboxyl functional groups, having 3 to 12, preferably 3 to 6 carbon atoms, Rₕ is an alkyl group of 12 to 72 carbon atoms, R_{f} is a fluoroalkyl group or 3 to 12 carbon atoms, Q is a divalent linking group, each (CO₂) group is non-directional, and m and n are each at least 1; and a second fluorochemical ester composition of formula (II)
R_{f}²—O—C(O)—R₁ or R_{f}—C(O)—O—R₁ (II)
wherein R_{f} is F(CF₂)ₓ—SO₂N(R₂)-R₃ wherein x is a positive integer from about 4 to about 20, R₂ is an alkyl radical of from 1 to about 4 carbon atoms, and R₃ is an alkylene radical of from 1 to about 12 carbon atoms; and R₁ is an aliphatic linear hydrocarbon having an average of from 12 to 66 carbon atoms.

### FIELD

This invention relates to the addition of certain fluorochemical diesters to polymer melts to impart superior repellency of low surface tension fluids to thermoplastic polymers, in particular fibers, fabrics, nonwovens, films and molded articles.

### BACKGROUND

Carpet and textile fibers are easily soiled and stained in everyday use. The problem of fiber soiling has become more difficult with the advent of synthetic fibers such as polypropylene, polyamide, polyethylene, and polyester, that are substantially more oleophilic (oil-loving) than traditional natural fibers such as cotton and wool.

A wide variety of materials are known to cause soiling. Soil found on fibers can include a variety of solid particles, such as fly ash or other inorganic particulates; liquids, such as oils and greases; mixtures of solids and liquids, such as soot (that contain particles mixed with oily components); and biological matter such as skin cells and sebum.

Soil typically adheres to the fiber surface by Van der Waals forces, that are effective only over very short distances. The strength of the bond depends on the forces of interaction per unit interfacial area, the area of contact, and whether a liquid is present on the fiber surface. Oily films on the fiber increase soiling. In general, the higher the viscosity of the liquid, the greater the adhesion of the liquid to the fiber. Soil particles can even adhere to initially smooth surfaces, such as polyester and polyethylene film. Soil is not commonly mechanically entrapped in the fiber.

Staining of a fiber can occur in a wide variety of ways, including through the ionic or covalent binding of an exogenous colored substance to the fiber. For example, nylon fibers are polyamides with terminal amino and carboxyl end groups. Nylon is commonly stained by acid dyes, which are colored, negatively charged molecules that ionically bind to the protonated terminal amine. Examples of staining acid dyes include liquids containing FD&C Red Dye No. 4, wine, and mustard.

For many years, soil (as opposed to stain) resistance has been imparted to carpet and textile fibers by applying a finish that repels oil and water. Perhaps the first soil resist agent for fibers was starch, that was removed along with the soil when the fiber was washed. Other water soluble polymeric stain resist finishes have included methylcellulose, hydroxypropyl starch, polyvinyl alcohol, alginic acid, hydroxyethyl cellulose, and sodium carboxymethyl cellulose. As with starch, the strong disadvantage of these protective finishes is that their mechanism of action is sacrificial; they contain the soil but are removed along with it when the fiber is cleaned.

Vinyl polymers including acrylics, methacrylics and polymers of maleic acid have also been used as soil release agents. U.S. Pat. No. 3,377,249 discloses emulsions of copolymers of ethyl acrylate with at least 20% acrylic, methacrylic, or itaconic acid in combination with N-methylol acrylamide.

More recently, fluorochemical soil release agents have become very popular. The fluorochemical agents are coated onto the fiber to prevent wetting of the surface by minimizing chemical contact between the surface and substances that can soil the carpet, making the substance easier to remove.

Early fluorochemical finishes focused on reducing the surface energy of the fiber to prevent the spreading of oily soils. More recently developed fluorochemical finishes have attempted to combine reduction in surface energy with hydrophilicity, as described in U.S. Pat. No. 3,728,151. A number of patents describe fluorinated polymers for use as soil resist coatings for fibers, including U.S. Pat. No. 3,759,874 (describing polyurethanes that consist of a combination of an oleophilic fluorine-containing block and a hydrophilic polyethyleneoxide block) and U.S. Pat. No. 4,046,944 (describing a fluorinated condensation block copolymer, that include oleophilic fluorinated blocks and hydrophilic polyethyleneoxide blocks connected by urea linkages).

Although fluorinated finishing coats on fibers do impart an amount of soil resistance to the fiber, they all suffer from the distinct disadvantage that they are removed by routine maintenance of the fiber. None of the fluorochemical finishes available to date provides permanent protection from soiling and staining. This is a particular problem for polypropylene, that is very oleophilic, and that has begun to compete with nylon as a fiber for use in residential carpets.

Thermoplastic polymer fibers are frequently treated with fluorochemical compounds in order to affect the surface characteristics of the fiber, for example to improve water repellency or to impart stain or dry soil resistance. Most frequently, fluorochemical dispersions are applied topically to the fabrics made from these fibers by spraying, padding or foaming, followed by a drying step to remove water.

For example, a method is known for obtaining dry soil resistance and nonflame propagating characteristics in a textile fiber by applying topically aqueous dispersions of a variety of fluorinated esters derived from perfluoroalkyl aliphatic alcohols of the formula CₙF₂ₙ₊₁ (CH₂)ₘOH where n is from about 3 to 14 and m is 1 to 3, together with mono- or polycarboxylic acids which contain from 3 to 30 carbons and can contain other substituents. The fluorinated esters include, among others, a perfluoroalkylethyl stearate corresponding to “ZONYL” FTS available from DuPont, as well as perfluoroalkylethyl diesters made from dodecanedioic acid or tridecanedioic acid.

It is well recognized that the process of manufacturing thermoplastic polymeric fibers and fabrics could be simplified and significant capital investment could be eliminated if the topical application were replaced by incorporating a fluorochemical additive into the polymer melt prior to the extrusion of the fiber. The difficulty has been in finding suitably effective fluorochemical additives.

Thermoplastic polymers include, among others, polyolefins, polyesters, polyamides and polyacrylates. Polyolefins, and in particular polypropylene, are frequently used for disposable nonwoven protective garments, particularly in the medical/surgical field, in part because of a polyolefin's inherent water-repellency. However, polyolefins are not inherently good repellents for other lower surface tension fluids frequently encountered in the medical field such as blood and isopropyl alcohol. To get around this deficiency, fluorochemical dispersions are applied topically to these fabrics.

The requirements of an additive suitable for incorporating into a polyolefin melt include, besides the ability to repel low surface tension fluids at a low concentration of the additive, a satisfactory thermal stability and low volatility to withstand processing conditions. Preferably the compound will migrate to the surface of the fiber so as to minimize the amount of additive needed for adequate repellency. While this migration can often be enhanced by post-extrusion heating of the fiber, it is more preferable for the migration to occur without the need for this heating step. This requirement for mobility in the polymeric fiber in turn tends to limit the size of the fluorochemical molecule, and effectively eliminates from consideration high molecular weight polymeric fluorochemical additives.

The general concept of incorporating fluorochemical additives into a polyolefin fiber melt is known, but the difficulty in finding suitable effective additives has limited the application of this concept. Many of the past efforts to evaluate such fluorochemical additives have been aimed at improving other properties of the polyolefin, and do not teach methods of its improving repellency to low surface tension fluids.

Nonwoven composite structures are known consisting in part of two or more melt-extruded nonwoven layers, at least one of which includes an additive which imparts to the surface at least one characteristic different than the surface characteristics of the polymer alone as a result of preferential migration of the additive to the surface without the need for post-formation treatment of any kind. Examples of the additive-including layer include polypropylene modified by commercially available fluorochemical additives, including “ZONYL” FTS defined above.

U.S. Pat. Nos. 5,178,931 and 5,178,932 disclose specific nonwoven laminiferous and composite structures respectively, consisting in part of three melt-extruded nonwoven layers, the second of which includes an additive which imparts alcohol repellency as a result of preferential migration of the additive to the surface without the need for post-formation treatment of any kind, and where at least one of the first and third layers has been treated by topical application of an agent to change its characteristics in some way. Examples of the additive-including second layer include commercially available fluorochemicals, including “ZONYL” FTS.

Soil resistant polymeric compositions are known which are prepared by melt extrusion with a nonpolymeric fluorochemical dispersed throughout the polymer. The polymers used include polypropylene, polyethylene, polyamide and polyester, and the fluorochemical used is a perfluoroalkylstearate, in particular “ZONYL” FTS.

In addition, a polymeric composition is known comprising a mixture of a polymer selected from the group of polypropylene, polyethylene, polyamide and polyester with a fluorochemical comprising a fluorinated oleophobic, hydrophobic alkyl group attached to a nonfluorinated oleophilic alkyl, aryl, aralkyl or alkaryl moiety optionally through a linking moiety, which can be melt extruded as a mixture. A more specific description of the above fluorochemical is not disclosed, but among the many compounds which are applicable are esters where the oleophilic organic group contains from 2 to 35 carbon atoms. Examples of such are “ZONYL” FTS or a product made by transesterifying “ZONYL” BA with methyl stearate and methyl palmitate.

An automotive coating film is known containing an organic solvent-soluble waxy hydrocarbon which possesses a fluorine-containing organic group. This component is a product obtained by esterifying and coupling a high molecular weight alcohol with a carboxylic acid which possesses a fluorine-containing group or a product obtained by esterifying and coupling a high molecular weight fatty acid and an alcohol which possesses a fluorine-containing group. As examples of high molecular weight alcohols included are those with average carbon chain lengths with up to 50 carbons. As examples of high molecular weight fatty acids included are those with carbon chain lengths of up to 31 carbons (mellisic acid). The products were tested only as a waxing agent for automobiles.

Japanese Patent Application 3-41160 teaches a thermoplastic resin composition containing a perfluoroalkyl group-containing long chain fatty ester of the formula R_{f}-R₁—OCO—R₂ where R_{f} is a perfluoroalkyl group with 5 to 16 carbons, R₁ is an alkylene group with 1 to 4 carbons, and R₂ is an unsaturated alkyl group or a saturated alkyl group with 21 to 50 carbons. One example reacts C₈F₁₇C₂H₄OH with C₂₇H₅₅COOH to produce the ester. The resins included polyethylene and polypropylene. Benefits of the additive were shown by the contact angle of water with molded articles of the resin. No tests are reported on the repellency to low surface tension fluids of the resulting polymers.

U.S. Pat. Nos. 5,560,992 and 5,977,390 disclose soil resistant thermoplastic polymers containing a fluorochemical.

In summary, while the prior art discloses numerous examples of polyolefin fibers containing a fluorochemical additive incorporated at the melt stage to alter the surface characteristics of the extruded fiber, much of this was aimed at soiling and staining resistance, water repellency or other purposes. A need exists to achieve superior repellency to low surface tension fluids and superior product efficiency.

### SUMMARY

The present invention comprises a composition and a process for imparting repellency of low surface tension fluids to thermoplastic polymer articles. The composition having repellency to low surface tension fluids of the present invention comprises a material prepared by:
(a) forming a mixture of (1) a thermoplastic polymer; (2) a first fluorochemical ester composition of the formula (I):
   [Rₕ(CO₂)]ₘ-A-[(CO₂)-QR_{f}¹]ₙ (I)
   wherein A is the residue of a polyol, polyacid or mixed hydroxy acid, optionally having one or more unreacted hydroxyl or carboxyl functional groups, having 3 to 12, preferably 3 to 6 carbon atoms, Rₕ is an alkyl group of 12 to 72 carbon atoms, R_{f} is a fluoroalkyl group or 3 to 12 carbon atoms, Q is a divalent linking group, each (CO₂) group is non-directional, and m and n are each at least 1; and (3) a second fluorochemical ester composition of formula (II)
   R_{f}²—O—C(O)—R₁ or R_{f}—C(O)—O—R₁ (II)
   wherein R_{f} is F(CF₂)ₓ—SO₂N(R₂)—R₃ wherein x is a positive integer from about 4 to about 20, R₂ is an alkyl radical of from 1 to about 4 carbon atoms, and R₃ is an alkylene radical of from 1 to about 12 carbon atoms; and R₁ is an aliphatic linear hydrocarbon having an average of from 12 to 66 carbon atoms;
and (b) melt extruding the mixture.

Compositions of the invention yield polymeric articles that exhibit a surprisingly good combination of oil repellency and water repellency.

The present invention further comprises the above composition in the form of a filament, fiber, nonwoven fabric or web, film or molded article.

The present invention further comprises a process for imparting repellency of low surface tension fluids to a thermoplastic polymer article comprising forming a mixture prior to article formation of a polymer and an effective amount of a fluorochemical compound comprising a fluorocarbon ester as defined above and melt extruding the mixture. Such articles include filaments, fibers, nonwoven webs or fabrics, films or molded articles.

### DETAILED DESCRIPTION

Superior repellency to low surface tension fluids is imparted to thermoplastic polymer articles, in particular fibers, fabrics, filaments, nonwovens, films, and molded articles, by the addition of certain monomeric fluorinated ester compounds to a polymer prior to article formation and melt extruding the resulting mixture. This process is used either with or without post-extrusion heating of the article to promote movement of the additive to the article surface, since the ester compounds of this invention tend by their nature to concentrate on the surface.

The term “low surface tension fluids” is used herein to mean fluids having a surface tension of less than 50 dynes/cm. Examples of such fluids include alcohols, blood, and certain body fluids.

The term fluorochemical, as used herein, refers to an organic nonpolymeric compound in which more than two of the hydrogens atoms attached directly to carbon have been replaced with fluorine, or an organic polymeric compound in which at least one hydrogen attached to a carbon in a monomer used to prepare the polymer or copolymer is replaced with fluorine. Fluorochemicals are sometimes also called fluorocarbons or fluorocarbon polymers. Fluorochemicals can include other halogen atoms bound to carbon, notably chlorine.

The presence of the fluorine atoms impart stability, inertness, nonflammability, hydrophobic, and oleophobic characteristics to the molecule. Fluorochemicals are typically more dense and more volatile than the corresponding hydrocarbons and have lower refractive indices, lower dielectric constants, lower solubilities, and lower surface tensions than the corresponding nonfluorinated compound or polymer.

The fluorochemical selected for extrusion with the polymer can be perfluorinated, wherein all of the hydrogens are replaced with fluorine atoms, or semifluorinated, wherein two or more, but not all, of the hydrogens are replaced with fluorine. Suitable fluorochemicals for use in preparation of the soil resistant fibers are small molecules, oligomers, or polymers, or mixtures of these. The fluorochemical can be added to the mechanical blender in a solid or liquid form.

The fluorochemical or mixture of fluorochemicals that is selected should not include any moiety that reacts adversely or degrades on extrusion. Nonlimiting examples of functional or functionalized moieties that can be included in the fluorochemical include alcohols, glycols, ketones, aldehydes, ethers, esters, amides, acids, acrylates, urethanes, ureas, alkanes, alkenes, alkynes, aromatics, heteroaromatics, and nitriles. The functionalized moieties in the fluorochemical must be compatible with, and not adversely react with, functional or functionalized moieties in the polymer fiber, and must not decompose into undesired products during extrusion.

The composition of the present invention comprises a material prepared by melt extruding forming a mixture of (1) a thermoplastic polymer; (2) a first fluorochemical ester of formula (I); and (3) a second fluorochemical ester composition of formula II; and

(b) melt extruding the mixture.

Preferably R1 has an average of from 24 to 29 carbon atoms.

The two esters are typically present in a weight ratio range of 1 part formula I and 3 parts formula II to 3 parts formula I and 1 part formula II. Such blends have been found to provide surprisingly good performance. The composition typically comprises a total of ester Formula A and Formula B of about 0.1 to about 5.0 weight percent. Compositions of the invention typically have a fluorine content of from about 200 to about 10,000 parts per million (by weight).

The first ester includes the compounds of the formula (I):
[Rₕ(CO₂)]ₘ-A-[(CO₂)-QR_{f}¹]ₙ (I)
wherein A is the residue of a polyol, polyacid or mixed hydroxy acid, optionally having one or more unreacted hydroxyl or carboxyl functional groups having 3 to 12, preferably 3 to 6 carbon atoms, Rₕ is an alkyl group of 12 to 72 carbon atoms, R_{f} is a fluoroalkyl group or 3 to 12 carbon atoms, Q is a divalent linking group, each (CO₂) group is non-directional, i.e. —O—C(O)—═—C(O)—O—, and m and n are each at least 1, preferably the sum of m+n is at least 3.

R_{f}¹ represents a perfluoroalkyl or perfluoroheteroalkyl group having from 3 to about 12 carbon atoms, preferably 3 to 8 carbon atoms, more preferably having from about 3 to about 5 carbon atoms; R_{f} can contain straight chain, branched chain, or cyclic fluorinated alkylene groups or combinations thereof with straight chain, branched chain or cyclic alkylene groups; R_{f}¹ is preferably free of polymerizable olefinic unsaturation and can optionally contain catenary heteroatoms such as oxygen, divalent or hexavalent sulfur, or nitrogen; a fully fluorinated radical is preferred, but hydrogen or chlorine atoms may be present as substituents provided that not more than one atom of either is present for every two carbon atoms; the terminal portion of the R_{f} group is fully fluorinated, preferably containing at least 7 fluorine atoms, e.g., CF₃CF₂CF₂—, (CF₃)₂CF—, —CF₂SF₅ or the like. Preferably, R_{f}¹ contains from about 40% to about 80% fluorine by weight, more preferably from about 50% to about 78% fluorine by weight; perfluorinated aliphatic groups (i.e., perfluoroalkyl groups of the formula CₙF₂ₙ₊₁—) are the most preferred embodiments of R_{f}.

The Rₕ moiety is derived from long-chain aliphatic monofunctional acids or alcohols having 12 to 72 carbons. Long-chain hydrocarbon groups typically have been known to impart poor oil repellency; however, the chemical compositions of the present invention comprising terminal long-chain hydrocarbon groups having 12 to 72 carbons impart good stain-release properties. Long-chain aliphatic monofunctional compounds suitable for use in the chemical compositions of the present invention comprise at least one, essentially unbranched, aliphatic alcohols and acids having from 12 to about 72 carbon atoms which may be saturated, unsaturated, or aromatic. These long-chain hydrocarbon alcohols or acids can be optionally substituted, for example, with groups such as one or more chlorine, bromine, trifluoromethyl, or phenyl groups. Representative long-chain hydrocarbon alcohols include 1-dodecanol, 1-tetradecanol, 1-hexadecanol,1-octadecanol, and the like, and mixtures thereof. Representative long-chain hydrocarbon carboxylic acids (or functional derivatives thereof, such as esters) include 1-dodecanoic acid, 1-tetradecanoic acid, 1-hexadecanoic acid, 1-octadecanoic acid, and the like, and mixtures thereof. Preferred long-chain hydrocarbon alcohols or acids have 12 to 50 carbon atoms, with 18-40 carbon atoms being more preferred for performance.

With respect to Formula I, the fluoroaliphatic group, R_{f}¹, is linked to the (—CO₂—) group by a linking group designated Q. Linking group Q can be a covalent bond, a heteroatom, e.g., O or S, or an organic moiety. The linking groups Q is are preferably organic moieties containing 1 to about 20 carbon atoms, and optionally containing oxygen, nitrogen-, or sulfur-containing groups or a combination thereof, and preferably free of functional groups, e.g., polymerizable olefinic double bonds, thiols, easily abstracted hydrogen atoms such as cumyl hydrogens, and other such functionality known to those skilled in the art, that substantially interfere with the preparation of the fluorochemical additives. Examples of structures suitable for linking group Q include straight chain, branched chain, or cyclic alkylene, arylene, aralkylene, oxy, oxo, thio, sulfonyl, sulfinyl, imino, sulfonamido, carboxamido, carbonyloxy, urethanylene, ureylene, and combinations thereof such as sulfonamidoalkylene.

Preferred linking group Q can be selected according to ease of preparation and commercial availability.

The A moiety is derived from a polyfunctional alcohol, acid (or derivative thereof, such as a ester, acyl halide or anhydride) or mixed hydroxy acids such as citric acid, having from 3 to 12, preferably 3 to 6 carbon atoms, and which may be further substituted by one of more unreacted hydroxy or carboxyl functional groups.

A wide range of fluorocarbon hydrocarbon polymers are known, including polytetrafluoroethylene, polymers of chlorotrifluoroethylene, fluorinated ethylene-propylene polymers, polyvinylidene fluoride, and poly(hexafluoropropylene). A variety of fluorochemicals are available Commercially, many from E. I. Du Pont Nemours and Company, Wilmington, Del. Other fluorochemicals that can be used include those that are now used commercially in fluorochemicals coatings, including Scotchgard™ 358 and 352 (3M Co.), Zonyl™ 5180 Fluorochemical dispersion, and Teflon™ Toughcoat Anionic (E. I. Du Pont de Nemours and Company, Inc.). Zonyl™ 5180 is an aqueous fluorochemical dispersion containing a 1-10% polyfunctional perfluoroalkyl ester mixture, 10-20% polymethylmethacrylate, and 70-75% water. Teflon™ Toughcoat Anionic contains 5-10% perfluoroalkyl substituted urethanes, 1-5% polyfunctional perfluoroalkyl esters, and 85-90% water.

If the fluorochemical is obtained as a water based emulsion, the emulsifiers and water should be removed before the fluorochemical is added to the blender with the polymer.

In a preferred embodiment, a fluorochemical is used that has a fluorinated alkyl group attached to a nonfluorinated oleophilic, alkyl, aryl, alkaryl or aralkyl group through a linking moiety. The fluorinated alkyl group tends to migrate through the fiber to the surface because it is both oleophobic and hydrophobic. The nonfluorinated oleophilic group remains anchored in the fiber. A fluorochemical containing a combination of a fluorinated alkyl group attached to a nonfluorinated organic group, thus, provides surface soil resistance and yet is held in the fiber. The linking moiety can be any chemical group that does not significantly adversely affect the desired performance of the fluorochemical, nor chemically react with the fiber.

Nonlimiting examples of fluoroaliphatic group-containing compounds useful for the preparation of soil resistant fibers are illustrated in Formula I.

In Formula II, R_{f}² is a fluorinated aliphatic moiety. R_{f}² is preferably saturated, mono-valent and has at least 4 fully-fluorinated carbon atoms. It can be straight, branched, or, if sufficiently large, cyclic, or, alternatively, can contain a combination of straight, branched, or cyclic groups, for example a alkylcycloaliphatic radical. The skeletal chain in the fluoroaliphatic group can include hetero atoms (i.e., atoms other than carbon) bonded only to carbon atoms or the skeletal chain. Hydrogen or chlorine atoms can also be present as substituents in the R_{f}² moiety. While R_{f}² can contain a large number of carbon atoms, compounds with R_{f}² moieties of up to 20 carbon atoms are typically adequate, such as CF₃(CF₂)ₘ—, wherein m is from 3 to 20. The terminal portion of the R_{f}² group preferably has at least four fully fluorinated carbon atoms, e.g., CF₃CF₂CF₂CF₂—, and the preferred compounds are those in which the R_{f}² group is fully or substantially fluorinated, as in the case where R_{f}² is perfluoroalkyl, e.g., CF₃(CF₂)ₙ—, or CF₃(CF₂)ₙCH₂CH₂—, wherein n is 1-19. Suitable R_{f}² groups include for example, C₈F₁₇—, C₆F₁₃CH₂CH₂—, FSC₃F₆—, C₁₀F₂₁CH₂CH₂—, CF₃CF₂CF₂CF₂—, and HCF₂CF₂CF₂CF₂—.

Examples of fluorochemicals include those wherein R_{f}CH₂CH₂OH (or a mixture of fluorinated alcohols), or the corresponding amine (or mixture of amines) is reacted with a mono or poly functional reactive intermediate to provide corresponding fluorinated esters and urethanes, as illustrated below. For example a fluorinated alkyl ethyl alcohol, for example, CₙFe₍₂ₙ₊₁₎CH₂CH₂OH, wherein n is from 4 to 20 can be reacted with a di or polycarboxylic acid, including but not limited to sebacic acid, phthalic acid. terephthalic acid, isophthalic acid, adipic-acid. 1,10-dodecanoic acid, bis(p-carboxyphenoxyalkane), fumaric acid, 1,4-diphenylenediacrylic acid, branched monomers such as 1,3,5-benzenetricarboxylic acid, azeleic acid, pimelic acid, suberic acid (octanedioic acid), itaconic acid, biphenyl-4,4′-dicarboxylic acid, benzophenone-4,4′-dicarboxylic acid, p-carboxyphenoxyalkanoic acid, hydroquinone-O,O-diacetic acid, 1,4-bis-carboxymethyl benzene, 2,2-bis-(4-hydroxyphenyl)propane-O,O-diacetic acid, 1,4-phenylene-dipropionic acid, and cyclohexane dicarboxylic acid. Citric acid can also be reacted with the fluorinated alcohol or amine to provide a useful fluorochemical.

Polymeric compositions that are permanently soil resistant are prepared that have fluorochemical dispersed throughout the polymer. Carpet and textile fibers prepared in this way have reduced surface energy and low static properties relative to the fiber without the fluorochemical. The fibers represent a significant advance in fiber and textile technology, in that the fluorochemical is dispersed throughout the polymer instead of coated onto the fiber, and is not removed from the fiber on washing.

The dispersion of the fluorochemical in the polymer improves characteristics of the polymer other than soil resistance. For example, polypropylene fibers that are extruded without a fluorochemical are highly static. Antistatic agents must be applied to the fiber after extrusion to keep the fiber from breaking or static clinging during later processing steps. However, the antistatic agents must be removed from the fiber by scouring after the fiber is tufted because they can increase the tendency of the fiber to soil on use. This process is cumbersome and increases the cost of the fiber. Polymers, and in particular polypropylene fibers, extruded with a fluorochemical do not require antistatic agents to facilitate handling, because they have inherently low static energy.

Fluorochemicals also impart antiwetting characteristics to polymers that are useful for a number of applications. For example, the fluorochemical can be extruded with a polymer into a thin film that repels water. This is particularly useful for certain manufacturing procedures that require a dry film for the application, for example, addition of an adhesive to a recently extruded film. Dispersion of the fluorochemical into the polymer also decreases the flammability and alters the combustion characteristics of the polymer.

Thermoplastic Polymer

The term “copolymer” as used herein includes polymers formed by the polymerization of at least two different monomers; a monomer and a polymer; or two or more polymers or oligomers. For simplicity, the term polymer as used herein includes copolymers and mixtures of polymers.

Any polymer, copolymer, or mixture of polymers is suitable for use in the soil resistant fiber that can be melt extruded and that is compatible with the desired fluorochemical. Common polymers that are typically melt extruded include nylon 6, polyester, polypropylene, and polyethylene.

A polymer should be selected that, when combined with the fluorochemical, has an appropriate viscosity and shear rate on extrusion. It should solidify within a reasonable time to a filament with appropriate characteristics for the desired function, including tensile strength (strain), elongation (stress), modulus, crystallinity, glass transition temperature, and melt temperature. These characteristics can be measured by known methods.

PCT/US92/05906 discloses a method for the preparation of polyurethane compositions with low surface energy that includes polymerizing a mixture comprising polyisocyanate, polyol, and a non-reactive fluoroaliphatic moiety of the types disclosed herein. The polyurethane is not prepared by simple extrusion of the fluorochemical with a preformed polyurethane, but instead by reactive extrusion, in which the monomers are actually polymerized in the presence of the fluorochemical. In contrast, in this invention, preformed polymers are simply melt extruded with the fluorochemical to form a soil resistant material.

Extrusion

There are various methods by which the above compounds can be prepared, and the inventive process is not limited to a particular method of preparation. For example, the above compounds are conveniently made by reacting an appropriate fatty alcohol with the appropriate fluorocarbon acid to form an acid ester, or by reacting an appropriate fatty acid with the appropriate fluorocarbon alcohol. Other compounds in these groups are readily made by those skilled in the art by following similar processes.

The esters useful in this invention are mixed with thermoplastic polymers by adding them to pelletized, granular, powdered or other appropriate forms of the polymers and rolling, agitating or compounding the mixture to achieve a uniform mixture which is then melt extruded. Alternatively the esters are added to a polymer melt to form a mixture which is then melt extruded. The thermoplastic polymer is a polyolefin, polyester, polyamide, or polyacrylate. The thermoplastic polymer preferably is a polyolefin, mixture or blend of one or more polyolefins, a polyolefin copolymer, mixture of polyolefin copolymers, or a mixture of at least one polyolefin and at least one polyolefin copolymer. The thermoplastic polymer is more preferably a polyolefin polymer or copolymer wherein the polymer unit or copolymer unit is ethylene, propylene or butylene or mixtures thereof. Thus the polyolefin is preferably polypropylene, polyethylene, polybutylene or a blend or copolymer thereof.

The amount of the fluorinated compound to be added to the thermoplastic polymer is preferably between 0.1 and about 5% by weight of the polymer. Amounts above this range can be used but are unnecessarily expensive in relation to the benefit received. The blend is then melted and extruded into fibers, filaments, nonwoven webs or fabrics, films, or molded articles using known methods.

Extrusion is used to form various types of nonwovens. In particular, extrusion is used to form a melt blown nonwoven web of continuous and randomly deposited microfibers having an average diameter of approximately 0.1 to 15 or more microns, preferably in the range of about 3 to 5 microns. The melt extrusion is carried out through a die at a resin flow rate of at least 0.1 to 5 grams per minute per hole, with the microfibers being randomly deposited on a moving support to form the web.

In the above melt blowing process, polymer and a compound of the present invention are fed into an extruder where it is melted and passed through a die containing a row of tiny orifices. As the polymer emerges from the die, it is contacted by two converging, high-velocity hot air streams, which attenuate the polymer into a blast of fine, discontinuous fibers of 0.1 to 10 microns in diameter. The useful polymer throughputs or flow rates range from 0.1 to 5 grams per minute per hole. Typical gas flow rates range from 2.5 to 100 pounds per square inch (1.72×10⁵ to 6.89×10⁵ Pa) per minute of gas outlet area. The air temperature ranges from about 400° F. (204° C.) to 750° F. (399° C.). Cooling air then quenches the fibers, and they are deposited as a random, entangled web on a moving screen which is placed 6 to 12 inches (15.2 to 30.5 cm) in front of the blast of fibers.

Melt blowing processes are described in further detail in articles by V. A. Wente, “Superfine Thermoplastic Fibers”, Industrial and Engineering Chemistry, Vol. 48(8), pp 1342-1346 (1956); and by R. R. Buntin and D. T. Lohkamp, “Melt Blowing—A One-step Web Process for New Nonwoven Products”, Journal of the Technical Association of the Pulp and Paper Industry, Vol. 56(4), pp 74-77 (1973); as well as in U.S. Pat. No. 3,972,759. The disclosures of these documents are hereby incorporated by reference.

The unique properties of a melt blown nonwoven web comprised of a random array of fine, entangled fibers include very large surface areas, very small pore sizes, moderate strength and light weight fabric structure. These properties make the nonwoven webs particularly suitable for such applications as medical fabrics where barrier properties as well as breathability and drape are important.

Extrusion is also used to form polymeric films. In film applications, a film forming polymer is simultaneously melted and mixed as it is conveyed through the extruder by a rotating screw or screws and then is forced out through a slot or flat die, for example, where the film is quenched by a variety of techniques known to those skilled in the art. The films optionally are oriented prior to quenching by drawing or stretching the film at elevated temperatures.

Molded articles are produced by pressing or by injecting molten polymer from a melt extruder as described above into a mold where the polymer solidifies. Typical melt forming techniques include injection molding, blow molding, compression molding and extrusion, and are well known to those skilled in the art. The molded article is then ejected from the mold and optionally heat-treated to effect migration of the polymer additives to the surface of the article.

An optional heating or annealing step can be conducted but is not required. The polymer melt or extruded fiber, filament, nonwoven web or fabric, film, or molded article is heated to a temperature of from about 25° C. to about 150° C. The heating in some cases may improve the effectiveness of the fluorochemical additive in imparting alcohol repellency.

The compositions of the present invention are useful in various fibers, filaments, nonwoven webs or fabrics, films and molded articles. Examples include fibers for use in fabrics and carpets, nonwoven fabrics used in protective garments used in the medical/surgical field, and molded plastic articles of many types. The process of the present invention is useful for imparting repellency of low surface tension fluids to various thermoplastic polymer articles such as filaments, fibers, nonwoven webs or fabrics, films and molded articles.

Soil resistant fibers can also be prepared by thin core coextrusion, that involves the extrusion of an inner core of a polymer with an outer core of a polymer that has fluorochemical embedded in it. Machinery appropriate for thin-core coextrusion is available from Hills Research corporation in Florida. For durability, an inner polymer core should be chosen that adheres sufficiently to the outer soil resistant polymeric composition. Thin core coextrusion can be used to prepare a wide variety of fibers for varying applications at varying costs. For example, a less expensive polymer can be used as an inner core of the fiber, and the desired polymer with fluorochemical soil protection as the outer core. Alternatively, a soil resistant fiber can be strengthened with a strong inner polymer core. Nonlimiting examples include fibers prepared by coextruding a polypropylene inner core with a polyamide/fluorochemical outer core, a polyamide inner core with a polypropylene/fluorochemical outer core, a polyethylene inner core with a polypropylene/fluorochemical outer core, a polypropylene inner core with a polyethylene/fluorochemical outer core, a polyethylene inner core with a polyamide/fluorochemical outer core, a polyamide inner core with a polyethylene/fluorochemical outer core, a polyester inner core with a polyamide/fluorochemical outer core, a polyamide inner core with a polyester/fluorochemical outer core, a polyethylene inner core and a polyester/fluorochemical outer core, a polypropylene inner core and a polyester/fluorochemical outer core, a polyester inner core and a polyethylene/fluorochemical outer core, a polyester inner core and a polypropylene/fluorochemical outer core, and variations of these.

The temperature of extrusion will vary depending on the polymer and fluorochemical used in the process. Typical extrusion temperatures vary from 100° F. to 800° F., however, extrusion temperatures outside this range may be required in certain processes. The fiber denier will also vary depending on the product being prepared, and are typically within the range of 1 to 50,000. Carpet fibers typically range from 900 denier to 8000 denier.

A wide variety of textile treatment chemicals can be added to the extrusion process to improve the properties of the product. Examples include antioxidants, flame retardants, ultra-violet absorbers, dyes or coloring agents, and microbiocidal agents, including antibacterial agents, antifungals, and antialgals. Any commercially available textile treatment chemical that does not degrade or adversely react in the extrusion process is appropriate. Commercially available flame retardants include alumina trihydrate, calcium carbonate, magnesium carbonate, barium carbonate, metal oxides, borates, sulfonates, and phosphates.

### EXAMPLES

The following illustrative examples were performed using the indicated test methods.

Water Repellency Test—Nonwoven web samples were evaluated for water repellency using 3M Water Repellency Test V for Floorcoverings (February 1994), available from 3M Company. In this test, samples are challenged to penetrations by blends of deionized water and isopropyl alcohol (IPA). Each blend is assigned a rating number as shown below.

| Water Repellency Rating | |
|---|---|
| Number | Blend (% by volume) |
| 0 | 100% water |
| 1 | 90/10 water/IPA |
| 2 | 80/20 water/IPA |
| 3 | 70/30 water/IPA |
| 4 | 60/40 water/IPA |
| 5 | 50/50 water/IPA |
| 6 | 40/60 water/IPA |
| 7 | 30/70 water/IPA |
| 8 | 20/80 water/IPA |
| 9 | 10/90 water/IPA |
| 10 | 100% IPA |

In running the Water Repellency Test, a nonwoven web sample is placed on a flat, horizontal surface. Five small drops of water or a water/IPA mixture are gently placed at points at least two inches apart on the sample. If, after observing for ten seconds at a 45° angle, four of the five drops are visible as a sphere or a hemisphere, the nonwoven web sample is deemed to pass the test. The reported water repellency rating corresponds to the highest numbered water or water/IPA mixture for which the nonwoven sample passes the described test. It is desirable to have a water repellency rating of at least 4, preferably at least 6.

Oil Repellency Test—Nonwoven web samples were evaluated for oil repellency using 3M Oil Repellency Test III (February 1994), available from 3M Company, St. Paul, Minn. In this test, samples are challenged to penetration by oil or oil mixtures of varying surface tensions. Oils and oil mixtures are given a rating corresponding to the following:

| Oil Repellency Rating | |
|---|---|
| Number | Oil Composition |
| 0 | (fails Kaydol ™ mineral oil) |
| 1 | Kaydol ™ mineral oil |
| 2 | 65/35 (vol) mineral oil/n-hexadecane |
| 3 | n-hexadecane |
| 4 | n-tetradecane |
| 5 | n-dodecane |
| 6 | n-decane |
| 7 | n-octane |
| 8 | n-heptane |

The Oil Repellency Test is run in the same manner as is the Water Repellency Test, with the reported oil repellency rating corresponding to the highest oil or oil mixture for which the nonwoven web sample passes the test. It is desirable to have an oil repellency rating of at least 1, preferably at least 3.

Melt Blown Extrusion Procedure

The extruder used was a Brabender CTSE-V counter-rotating conical twin screw extruder, with maximum extrusion temperature of approximately 220° C. and with the distance to the collector of approximately 11 inches.

The fluorochemical and thermoplastic polymer were each weighed and mixed in a paperboard container. Using a mixer head affixed to a basic hand drill they were then mixed for about one minute until a visually homogeneous mixture was obtained. This mixture was then added to the extruder hopper.

The process conditions for each mixture were the same, including the melt blowing die construction used to blow the microfiber web, the basis weight of the web (50±5 g/m²) and the diameter of the microfibers (10 to 15 micrometers). The extrusion temperature was approximately 220° C., the primary air temperature was 220° C., the pressure was 7 psi (48 kPa), with a 0.030 inch (0.76 cm) air gap width and the polymer throughput rate was about 10 lbs/hr.

Preparation of Citrate Ester

Citrate ester can be prepared as described for FC-350 in Example US publication no. U.S. 20030228459.

Preparation of Unicid 350-MEFBSE Ester

Unicid 350-MEFBSE ester can be prepared as describe in U.S. Pat. No. 6,063,474.

### EXAMPLES

The fluorochemical esters and ester blends in Table 1 were mixed with (Escorene™ PP 3505G having a melt flow index) polypropylene at the weight percent level (based on the weight of the polypropylene) shown in Table 1, and the mixtures were thermally extruded into nonwoven webs using the Melt Blown Extrusion Procedure described above. The nonwoven webs were evaluated for repellency using the Water Repellency Test and the Oil Repellency Test described above. The samples were tested 1) immediately after collection of the fiber to form a web, 2) after 24 hours at room temperature, and 3) after annealing 100° C. and 120° C. for 2 minutes followed by sitting at room temperature for 24 hours. The water and oil repellency data are also provided in Table 1.

TABLE 1

| | Fluoro- | | | Water | | | Oil | |
|---|---|---|---|---|---|---|---|---|
| | chemical | % FC | | Repellency | 100° C. | | Repellency | 100° C. |
| Example | (FC)Ester | Ester | Initial | 24 hrs | 24 hrs | Initial | 24 hrs | 24 hrs |
| Control 1 | Citrate ester | 1.5 | 4 | 4 | 7 | 0 | 0 | 7 |
| Control 2 | Unicid 350- | 1.5 | | | | | | |
| | MEFBSE | | | | | | | |
| | ester | | 4 | 9 | 7 | 0 | 1 | 0 |
| Control 3 | Unicid 350- | 1.0 | | | | | | |
| | MEFBSE | | | | | | | |
| | ester | | 3 | 10 | — | 0 | 0 | — |
| 1 | Citrate ester: | 1.5 | | | | | | |
| | Unicid 350- | | | | | | | |
| | MEFBSE | | | | | | | |
| | [symbol] ster 25:75 | | 4 | 9 | 8 | 0 | 2 | 4 |
| 2 | Citrate ester: | 1.5 | | | | | | |
| | Unicid 350- | | | | | | | |
| | MEFBSE | | | | | | | |
| | [symbol] ster 25:75 | | 3 | 7 | — | 0 | 2 | — |
| 3 | Citrate ester: | 1.5 | | | | | | |
| | Unicid 350- | | | | | | | |
| | MEFBSE | | | | | | | |
| | [symbol] ster 25:75 | | 3 | 5 | — | 0 | 1 | — |

What is claimed is:

1. A composition comprising a material prepared by:
(a) forming a mixture of (1) a thermoplastic polymer; (2) a first fluorochemical ester composition of the formula I:
[Rₕ(CO₂)]ₘ-A-[(CO2)-QR_{f}¹]ₙ (I)
wherein A is the residue of a polyol or polyacid optionally having one or more unreacted hydroxyl or carboxyl functional groups, Rₕ is an alkyl group of 12 to 72 carbon atoms, R_{f} is a fluoroalkyl group or 3 to 12 carbon atoms, Q is a divalent linking group, each (CO₂) group is non-directional, and m and n are each at least 1; and (3) a second fluorochemical ester composition of formula II:
R_{f}²—O—C(O)—R₁ or R_{f}²—C(O)—O—R₁ (II)
wherein R_{f}² is F(CF₂)x—SO₂N(R₂)-R3 wherein x is a positive integer from about 4 to about 20, R₂ is an alkyl radical of from 1 to about 4 carbon atoms, and R₃ is an alkylene radical of from 1 to about 12 carbon atoms; and R₁ is an aliphatic linear hydrocarbon having an average of from 12 to 66 carbon atoms;
and (b) melt extruding the mixture.

2. The composition of claim 1 wherein said thermoplastic polymer is a thermoplastic polymer selected from the group consisting of polyolefin, polyamide, polyester, polyacrylate, polyurethane, and blends and copolymers thereof.
